(19) United States
(12) Patent Application Publication
(10) Pub. No.: US 2026/0245017 A1
(43) Pub. Date: Aug. 20, 2026

(54) RISK INFORMATION GENERATION APPARATUS, RISK INFORMATION GENERATION METHOD, AND NON-TRANSITORY COMPUTER READABLE MEDIUM

(71) Applicant: NEC Corporation, Tokyo (JP)

(72) Inventors: Miho IKEMATSU, Tokyo (JP); Ikuo TERAZAWA, Tokyo (JP)

(73) Assignee: NEC Corporation, Tokyo (JP)

(21) Appl. No.: 19/531,861

(22) Filed: Feb. 6, 2026

(30) Foreign Application Priority Data
Feb. 17, 2025 (JP) 2025-023524

(51) Int. Cl. G06Q 10/0635

(52) U.S. Cl. CPC G06Q 10/0635

(57) ABSTRACT

A risk information generation apparatus according to the present disclosure acquires audit information indicating a result of a security audit performed on a target entity, determines adequacy of security measures in the target entity by using the audit information, determines an influence degree of the target entity on a related entity related to the target entity, and generates risk information indicating the adequacy and the influence degree.

### INCORPORATION BY REFERENCE

This application is based upon and claims the benefit of priority from Japanese patent application No. 2025-023524, filed on February 17, 2025, the disclosure of which is incorporated herein in its entirety by reference.

### TECHNICAL FIELD

The present disclosure relates to a risk information generation apparatus, a risk information generation method, and a program.

### BACKGROUND ART

Risk is evaluated in companies and the like. For example, JP 2003-140987 A discloses a system that executes a security audit on each node connected to a network to be subjected to the security audit and discloses a result of the audit. The audit result can be aggregated and published for each organization such as a business department.

### SUMMARY

An index for evaluating the risk is not limited only to the result of the security audit in each organization or the like. The present disclosure has been made in view of this problem, and an example object of the present disclosure is to provide a new technology for facilitating grasping of a risk.

A risk information generation apparatus according to an example aspect of the present disclosure comprises: at least one memory that is configured to store instructions; and at least one processor that is configured to execute the instructions to: acquire audit information indicating a result of a security audit performed on a target entity; determine adequacy of security measures in the target entity by using the audit information; determine an influence degree of the target entity on a related entity related to the target entity; and generate risk information indicating the adequacy and the influence degree.

A risk information generation method according to an example aspect of the present disclosure is executed by at least one computer. The risk information generation method comprises performed by at least one computer, comprises: acquiring audit information indicating a result of a security audit performed on a target entity; determining adequacy of security measures in the target entity by using the audit information; determining an influence degree of the target entity on a related entity related to the target entity; and generating risk information indicating the adequacy and the influence degree.

A non-transitory computer readable medium according to an example aspect of the present disclosure stores a program that causes at least one computer to execute: acquiring audit information indicating a result of a security audit performed on a target entity; determining adequacy of security measures in the target entity by using the audit information; determining an influence degree of the target entity on a related entity related to the target entity; and generating risk information indicating the adequacy and the influence degree.

According to the present disclosure, a new technology for facilitating grasping of a risk is provided.

### BRIEF DESCRIPTION OF THE DRAWINGS

FIG. 1 is a diagram illustrating an outline of an operation of a risk information generation apparatus;

FIG. 2 is a block diagram illustrating a functional configuration of the risk information generation apparatus;

FIG. 3 is a block diagram illustrating a hardware configuration of a

computer that implements the risk information generation apparatus;

FIG. 4 is a flowchart illustrating a flow of processing executed by the risk information generation apparatus;

FIG. 5 is a diagram illustrating a risk graph;

FIG. 6 is a second diagram illustrating the risk graph;

FIG. 7 illustrates a risk graph in which information on a plurality of target entities is aggregated; and

FIG. 8 is a diagram illustrating a risk graph further showing information regarding handling of personal information.

### EXAMPLE EMBODIMENT

Hereinafter, example embodiments of the present disclosure will be described in detail with reference to the drawings. In the drawings, the same or related elements are denoted by the same reference numerals, and repeated description is omitted as necessary for clarity of description. In addition, unless otherwise described, preset values such as predetermined values or threshold values are stored in advance in a storage device or the like accessible from an apparatus using the values. Furthermore, unless otherwise described, a storage unit includes one or more storage devices of any number.

### Outline

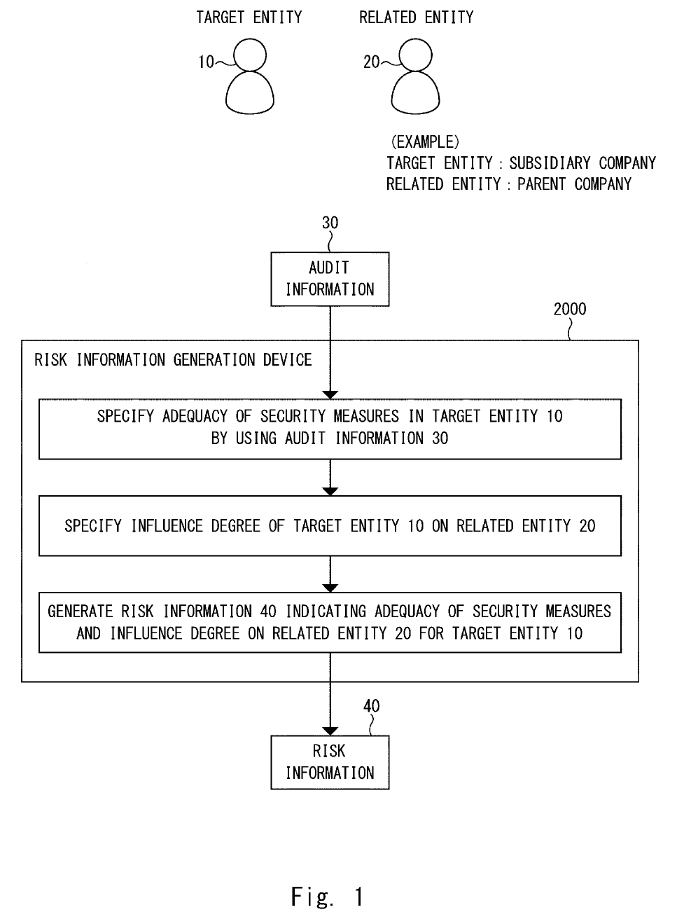

FIG. 1 is a diagram illustrating an outline of an operation of a risk information generation apparatus 2000. Here, FIG. 1 is a diagram for facilitating understanding of the outline of the risk information generation apparatus 2000, and the operation of the risk information generation apparatus 2000 is not limited to the operation illustrated in FIG. 1.

The risk information generation apparatus 2000 generates risk information 40 for a combination of a target entity 10 and a related entity 20. The risk information 40 indicates 1) the adequacy of security measures in the target entity 10, and 2) the degree of influence of the target entity 10 on the related entity 20.

The influence of the target entity 10 on the related entity 20 is, for example, in a case where some kind of incident associated with security occurs in the target entity 10, the influence received by the related entity 20 from the occurrence of the incident. The incident associated with security is, for example, information leakage, unauthorized access, malware infection, a system failure, or the like. The security measures are measures for preventing occurrence of various incidents described above.

Hereinafter, the adequacy of security measures is also referred to as “measure adequacy”. The influence degree of the target entity 10 on the related entity 20 is also expressed as “the influence degree of the target entity 10 on the related entity 20”.

An entity means any subject that performs business activities. For example, the entity is one company, one department, one team, one employee, or the like. In addition, for example, the entity may be one group including a plurality of companies, a plurality of departments, or a plurality of teams.

The target entity 10 and the related entity 20 are entities having some kind of association with each other in a business activity. If the target entity 10 and the related entity 20 are both companies, for example, the target entity 10 is a related company of the related entity 20. The related company of the related entity 20 is, for example, a company (e.g., a subsidiary company or a second- generation subsidiary company of the related entity 20) located below the related entity 20 in the hierarchy of the company group to which the related entity 20 belongs. In addition, for example, the related company of the related entity 20 is a company that receives outsourcing of business from the related entity 20. In addition, for example, the related company of the related entity 20 is a company that provides a product or a service (hereinafter, products and the like) to the related entity 20.

It is assumed that the target entity 10 and the related entity 20 are departments or teams. In this case, for example, the target entity 10 is a department or a team located below the related entity 20 in the hierarchy of departments or teams. In addition, for example, the target entity 10 is a department or a team that provides a result of an activity (e.g., manufactured part and the like) to the related entity 20.

In a case where the target entity 10 and the related entity 20 are employees, for example, the related entity 20 is a leader or the like of a department or a team to which the target entity 10 belongs.

The risk information generation apparatus 2000 generates the risk information 40 by, for example, the following method. The risk information generation apparatus 2000 acquires the audit information 30. The audit information 30 represents a result of the security audit performed on the target entity 10. The risk information generation apparatus 2000 determines the measure adequacy of the target entity 10 by using the audit information 30. The risk information generation apparatus 2000 further determines the influence degree of the target entity 10 on the related entity 20. Then, the risk information generation apparatus 2000 generates risk information 40 indicating the determined measure adequacy of the target entity 10 and the determined influence degree of the target entity 10 on the related entity 20.

### Example of Operation and Effect

According to the risk information generation apparatus 2000, the risk information 40 representing a pair of the adequacy of security measures and the influence degree of the target entity 10 related to the related entity 20 is generated for the target entity 10. Therefore, the adequacy of security measures and the influence degree of the target entity 10 on the related entity 20 can be grasped in combination for the target entity 10 by using the risk information generation apparatus 2000. As described above, according to the risk information generation apparatus 2000, a new technology for facilitating the grasping of the risk is provided.

Here, if an incident occurs in the target entity 10, the related entity 20 may also be affected. Therefore, adequacy of security measures in the target entity 10 is important for the related entity 20.

However, how important the adequacy of the security measures in the target entity 10 is for the related entity 20 depends on the magnitude of the influence of the occurrence of the incident in the target entity 10 on the related entity 20. Specifically, in a case where the occurrence of the incident in the target entity 10 has a relatively large influence on the related entity 20, the importance degree of the security measures being adequate in the target entity 10 becomes relatively high for the related entity 20. Specifically, in a case where the occurrence of the incident in the target entity 10 has a relatively small influence on the related entity 20, the importance degree of the security measures being adequate in the target entity 10 becomes relatively low for the related entity 20. Therefore, it is preferable that the adequacy of security measures in the target entity 10 and the influence degree of the target entity 10 on the related entity 20 can be grasped in combination.

According to the risk information generation apparatus 2000, the risk information 40 indicating the adequacy of security measures in the target entity 10 and the influence degree of the target entity 10 on the related entity 20 is provided. Therefore, it is possible to grasp, in combination, the adequacy of security measures in the target entity 10 and the influence degree of the target entity 10 on the related entity 20 that are preferably grasped in combination.

Hereinafter, the risk information generation apparatus 2000 according to the present example embodiment will be described in more detail.

### Example of Functional Configuration

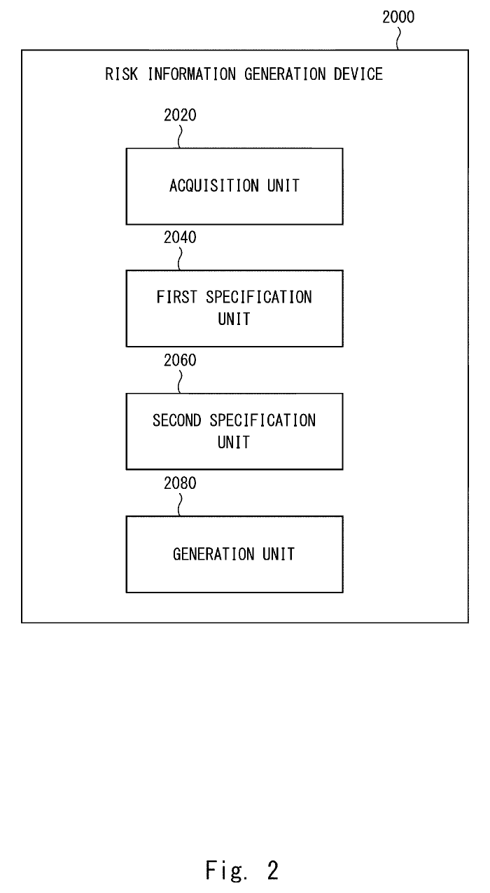

FIG. 2 is a block diagram illustrating a functional configuration of the risk information generation apparatus 2000. For example, the risk information generation apparatus 2000 includes an acquisition unit 2020, a first determination unit 2040, a second determination unit 2060, and a generation unit 2080. The acquisition unit 2020 acquires the audit information 30. The first determination unit 2040 determines the measure adequacy of the target entity 10 by using the audit information 30. The second determination unit 2060 determines the influence degree of the target entity 10 on the related entity 20. The generation unit 2080 generates the risk information 40 by using the measure adequacy determined by the first determination unit 2040 and the influence degree determined by the second determination unit 2060.

### Example of Hardware Configuration

Each functional component of the risk information generation apparatus 2000 may be achieved by hardware (e.g., a hard-wired electronic circuit etc.) that implements each functional component, or may be achieved by a combination of hardware and software (e.g., a combination of an electronic circuit and a program that controls the electronic circuit etc.). Hereinafter, a case where each functional component of the risk information generation apparatus 2000 is achieved by a combination of hardware and software will be further described.

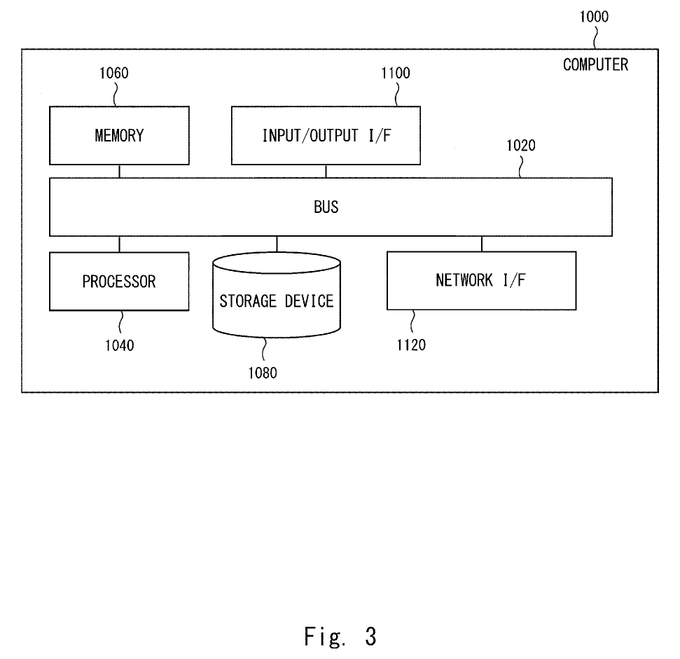

FIG. 3 is a block diagram illustrating a hardware configuration of a computer 1000 that achieves the risk information generation apparatus 2000. The computer 1000 is any computer. For example, the computer 1000 is a stationary computer such as a Personal Computer (PC) or a server machine. In another example, the computer 1000 is a portable computer such as a smartphone or a tablet terminal. In yet another example, the computer 1000 is an integrated circuit such as a System on Chip (SoC). The computer 1000 may be a dedicated computer designed to achieve the risk information generation apparatus 2000, or may be a general-purpose computer.

For example, each function of the risk information generation apparatus 2000 is implemented with the computer 1000 by installing a predetermined application with respect to the computer 1000. The application includes a program for implementing each functional component of the risk information generation apparatus 2000. The method of acquiring the program is optional. For example, the program can be acquired from a storage medium (Digital Versatile Disc (DVD), Universal Serial Bus (USB) memory, etc.) in which the program is stored. In addition, for example, the program can be acquired by downloading the program from a server apparatus that manages a storage device in which the program is stored.

The computer 1000 includes a bus 1020, a processor 1040, a memory 1060, a storage device 1080, an input/output interface 1100, and a network interface 1120. The bus 1020 is a data transmission path for the processor 1040, the memory 1060, the storage device 1080, the input/output interface 1100, and the network interface 1120 to transmit and receive data to and from each other. However, a method of connecting the processor 1040 and the like to each other is not limited to the bus connection.

The processor 1040 is an arithmetic device such as a Central Processing Unit (CPU), a Microprocessor Unit (MPU), a Graphics Processing Unit (GPU), a Digital Signal Processor (DSP), a Field-Programmable Gate Array (FPGA), or the like. The memory 1060 is a main storage device implemented by using a Random Access Memory (RAM) or the like. The storage device 1080 is an auxiliary storage device implemented using a hard disk, a Solid State Drive (SSD), a memory card, a Read Only Memory (ROM), or the like.

The input/output interface 1100 is an interface for connecting the computer 1000 with an input/output device. For example, an input device such as a keyboard and an output device such as a display device are connected to the input/output interface 1100.

The network interface 1120 is an interface for connecting the computer 1000 to a network. The network may be a Local Area Network (LAN) or a Wide Area Network (WAN).

The storage device 1080 stores the program (program for achieving above-described application) for achieving each functional component of the risk information generation apparatus 2000. The processor 1040 achieves each functional component of the risk information generation apparatus 2000 by reading this program from the memory 1060 and executing the same.

The risk information generation apparatus 2000 may be achieved by one computer 1000, or may be achieved by a plurality of computers 1000. In the latter case, the configurations of each of the computers 1000 do not need to be the same, and can be different from each other.

### Flow of Processing

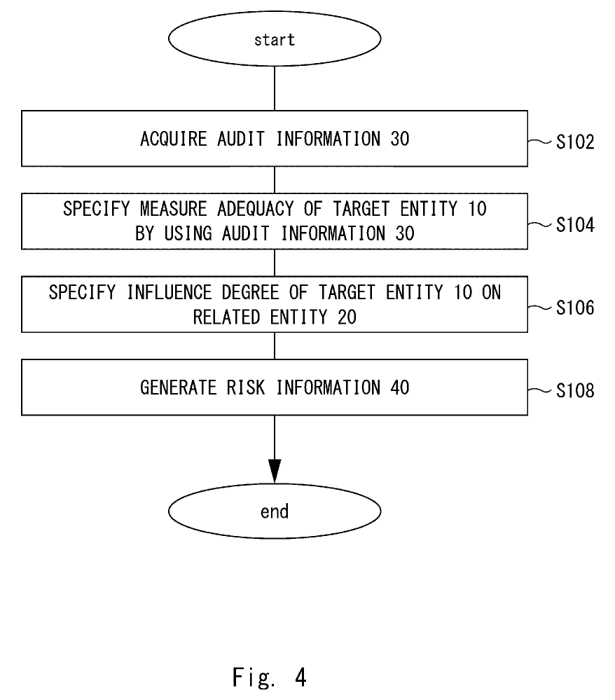

FIG. 4 is a flowchart illustrating a flow of processing executed by the risk information generation apparatus 2000. The acquisition unit 2020 acquires the audit information 30 (S102). The first determination unit 2040 determines the measure adequacy of the target entity 10 by using the audit information 30 (S104). The second determination unit 2060 determines the influence degree of the target entity 10 on the related entity 20 (S106). The generation unit 2080 generates the risk information 40 (S108).

### Acquisition of Audit Information 30: S102

The acquisition unit 2020 acquires the audit information 30 (S102). There are various methods for the acquisition unit 2020 to acquire the audit information 30. For example, the audit information 30 is stored in advance in any storage unit in a mode accessible from the risk information generation apparatus 2000. In this case, the acquisition unit 2020 acquires the audit information 30 by reading the audit information 30 from the storage unit. The audit information 30 to be read from the storage unit is designated, for example, by the user of the risk information generation apparatus 2000.

Here, it is assumed that the audit information 30 is stored in the storage unit for each of the plurality of entities. In this case, the acquisition unit 2020 acquires the audit information 30 on the target entity 10 from the plurality of pieces of audit information 30. For this purpose, for example, the acquisition unit 2020 receives designation of an identifier of an entity to be handled as the target entity 10. Then, the acquisition unit 2020 acquires the audit information 30 stored in the storage unit in association with the designated identifier as the audit information 30 of the target entity 10. As the identifier of the entity, any information (e.g., a name, an identification number, etc.) that can determine the entity can be used.

There are various methods for the acquisition unit 2020 to receive the designation of the target entity 10. For example, it is assumed that the risk information generation apparatus 2000 can be used via a web system. In this case, for example, the user of the risk information generation apparatus 2000 accesses the web system from a user terminal (a PC, a smartphone, etc.), and provides the identification information of the target entity 10 to the risk information generation apparatus 2000 via the web system.

The audit information 30 may be transmitted from another apparatus to the risk information generation apparatus 2000. In this case, the acquisition unit 2020 acquires the audit information 30 by receiving the audit information 30 transmitted from another apparatus. For example, the audit information 30 is provided from the user terminal to the risk information generation apparatus 2000 via the web system described above.

### Contents of Audit Information 30

The audit information 30 of the target entity 10 is information indicating a result of the security audit performed on the target entity 10. For example, the audit information 30 indicates the adequacy of the security measures in the target entity 10. The adequacy of the security measures is represented by, for example, a score within a predetermined range such as equal to or greater than 0 and equal to or less than 10. The score may be represented by an integer or may be represented by a decimal.

The audit information 30 may indicate the adequacy of the security measures in the target entity 10 for each of the plurality of security measures. In this case, for example, the audit information 30 indicates a score for each of the plurality of security measures.

The audit information 30 does not need to indicate all the results of the audit performed on the target entity 10, and may indicate information (e.g., the score described above) with which the adequacy of the security measures in the target entity 10 can be grasped.

### Determination of Measure adequacy: S104

The first determination unit 2040 determines the measure adequacy of the target entity 10 by using the audit information 30 (S104). For example, it is assumed that the audit information 30 indicates a score representing the adequacy of the security measures in the target entity 10. In this case, the first determination unit 2040 uses the score indicated in the audit information 30 as the measure adequacy.

In addition, for example, it is assumed that the audit information 30 indicates a score representing the adequacy of the security measures in the target entity 10 for each of the plurality of security measures. In this case, the first determination unit 2040 calculates statistical values of a plurality of scores indicated in the audit information 30, and uses the statistical values as the measure adequacy of the target entity 10. The statistical value is a simple sum, a weighted sum, a simple average, a weighted average, or the like. In a case where a weighted sum or a weighted average is used as the statistical value, the weight of each of the security measures is determined in advance. The information indicating the weight of each of the security measures is stored in advance in, for example, a storage unit accessible from the risk information generation apparatus 2000.

### Determination of Influence Degree: S106

The second determination unit 2060 determines the influence degree of the target entity 10 on the related entity 20 (S106). Hereinafter, a method of determining the influence degree will be exemplified.

For example, the second determination unit 2060 acquires information (hereinafter referred to as related information) indicating the association between the target entity 10 and the related entity 20, and determines the influence degree using the related information. A method of acquiring the related information is similar to the method of acquiring the audit information 30.

The related information indicates, for example, a type of association and content of association for the target entity 10 and the related entity 20. The type of association is represented by, for example, “same group”, “outsourcing”, “provision of the product or the like”, or the like. The type of association “same group” indicates that, for example, the target entity 10 and the related entity 20 are companies belonging to the same company group, departments, teams, or the like belonging to the same company, or the like. The type of association “outsourcing” indicates that the business is outsourced from the related entity 20 to the target entity 10. The type of association “provision of the product or the like” indicates that the product or the like is provided from the target entity 10 to the related entity 20.

The content of association indicated in the related information varies depending on a type of association between the target entity 10 and the related entity 20. It is assumed that type of association is “same group”. In this case, for example, the content of association indicates a positional relationship between the target entity 10 and the related entity 20 in the group. The positional relationship between the target entity 10 and the related entity 20 is represented by, for example, the position of the target entity 10 (a subsidiary company, a sibling company, or the like) with respect to the related entity 20, or the position of the related entity 20 (a parent company, a sibling company, or the like) with respect to the target entity 10.

It is assumed that type of association is “outsourcing”. In this case, for example, the content of association indicates the type of business that has been outsourced, the scale of the business, and the like. The types of business include, for example, various types such as a defense business, a space business, an infrastructure (infrastructure) business, an automobile business, and a home appliance business. In addition, the type of business may indicate whether the type of business applies to a specific type of business (e.g., specific important business). The scale of the business is represented by, for example, the total number of persons engaged in the business.

It is assumed that type of association is “provision of the product or the like”. In this case, for example, the content of association indicates the type of the provided product or the like, the scale of the provision, or the like. The scale of the provision of the product or the like is represented by, for example, the total number of products to be provided, the number of people engaged in the provided service, or sales and profit due to the provision. The sales and the profit are represented by, for example, numerical values for the most recent one year.

The second determination unit 2060 determines the influence degree using the related information. It is assumed that type of association is the same group. In this case, the second determination unit 2060 increases the influence degree of the target entity 10 on the related entity 20 as the distance between the target entity 10 and the related entity 20 in the group becomes shorter.

For example, it is assumed that a company group is represented by a graph in which entities represented by nodes are connected by edges. In this case, for example, the second determination unit 2060 uses the number of edges existing between the target entity 10 and the related entity 20 as the influence degree.

However, the distance represented by the edge may be different for each edge. In this case, the second determination unit 2060 uses the sum of the distances represented by each of the edges existing between the target entity 10 and the related entity 20 as the influence degree.

For example, the distance given to the edge indicating the positional relationship in the vertical direction (parent-child relationship etc.) is made larger than the distance given to the edge indicating the positional relationship in the horizontal direction (sibling relationship etc.). In this way, the influence degree due to the positional relationship in the vertical direction such as the parent-child relationship and the influence degree due to the positional relationship in the horizontal direction such as the sibling relationship can be increased.

It is assumed that type of association is the outsourcing. In this case, for example, the second determination unit 2060 determines the influence degree based on the type of business and the scale of business. For example, a score representing a level of influence is determined in advance for each type of business. In addition, a score representing the level of influence is determined in advance in association with each of a plurality of numerical ranges of the scale of the business. Here, as the scale of the business outsourced to the target entity 10 increases, a higher score is assigned.

The second determination unit 2060 determines a score based on the type of business and a score based on the scale of business using the related information, and calculates a statistical value of the determined scores. Then, the second determination unit 2060 uses the calculated statistical value as the influence degree. As the statistical value, a simple sum, a weighted sum, a simple average, a weighted average, or the like can be used. In a case where a weighted sum or a weighted average is used as the statistical value, a weight on each of the type of business and the scale of business is determined in advance. The information indicating these weights is stored in advance in, for example, a storage unit accessible from the risk information generation apparatus 2000.

It is assumed that a type of association is provision of the product or the like. In this case, for example, the second determination unit 2060 determines the influence degree based on the type of the product or the like and the scale of provision of the product or the like. For example, a score representing the level of influence is determined in advance for each type of product or the like. In addition, a score representing the level of influence is determined in advance in association with each of a plurality of numerical ranges of the scale of the provision. Here, as the scale of the provision of the product or the like by the target entity 10 increases, a higher score is assigned.

The second determination unit 2060 determines a score based on the type of the product or the like and a score based on the scale of provision using the related information, and calculates a statistical value of the determined scores. Then, the second determination unit 2060 uses the calculated statistical value as the influence degree. As the statistical value, a simple sum, a weighted sum, a simple average, a weighted average, or the like can be used. In a case where a weighted sum or a weighted average is used as the statistical value, a weight on each of the type of product or the like and the scale of provision is determined in advance. The information indicating these weights is stored in advance in, for example, a storage unit accessible from the risk information generation apparatus 2000.

The second determination unit 2060 may determine the influence degree using information other than the related information. For example, the second determination unit 2060 determines the influence degree of the target entity 10 on the related entity 20 based on the scale of the target entity 10. In this case, for the numerical value representing the scale of the target entity 10, a score is determined in advance in each of the plurality of numerical ranges. The second determination unit 2060 determines the score corresponding to the numerical range to which the scale of the target entity 10 belongs as the influence degree based on the scale of the target entity 10. A higher score is assigned the larger the scale of the target entity 10.

In a case where the scale of the target entity 10 is used to determine the influence degree, the second determination unit 2060 acquires information indicating the scale of the target entity 10. A method of acquiring the information is similar to the method of acquiring the audit information 30.

The scale of the entity 10 is represented by, for example, the number of affiliated persons, the number of group companies, the number of affiliated persons of a group company, the number of outsourcing companies, the number of outsourcing workers, sales, or profit. The number of affiliated persons of the entity represents the number of persons belonging to the entity (the number of employees belonging to the company, the number of members belonging to the department, the number of members belonging to the project team, etc.). The number of group companies of the entity represents, for a company group including the entity, the number of companies belonging to the company group (hereinafter referred to as group companies). The number of affiliated persons of the group company represents the total number of affiliated persons of each group company. The number of outsourcing companies of the entity represents the number of external companies to which the entity outsources business. The number of outsourcing workers represents the total number of persons involved in the outsourced business in the external company to which the business has been outsourced. The sales and the profit of the entity each represents the sales and the profit of the entity. For example, the sales and the profit are represented by numerical values for the most recent one year.

The second determination unit 2060 may determine the influence degree of the target entity 10 on the related entity 20 based on the degree of similarity between the name of the target entity 10 and the name of the related entity 20. Here, the influence degree is defined in such a way that the influence degree becomes higher the higher the similarity between the name of the target entity 10 and the name of the related entity 20. For example, the second determination unit 2060 calculates the similarity between the name of the target entity 10 and the name of the related entity 20, and uses the calculated similarity as the influence degree.

The similarity between the two names can be calculated using, for example, an editing distance or the like. Specifically, the second determination unit 2060 calculates the editing distance for the first text indicating the name of the target entity 10 and the second text indicating the name of the related entity 20. Then, the second determination unit 2060 calculates the similarity in such a way that the similarity becomes larger the smaller the calculated editing distance. For example, the inverse of the editing distance calculated for the first text and the second text is used for the similarity between the name of the target entity 10 and the name of the related entity 20.

The second determination unit 2060 may determine the influence degree of the target entity 10 on the related entity 20 in comprehensive consideration of the above-described various elements. For example, the second determination unit 2060 determines a first influence degree based on the related information, a second influence degree based on the scale of the target entity 10, and a third influence degree based on the similarity between the name of the target entity 10 and the name of the related entity 20. Then, the second determination unit 2060 uses the statistical values of the first influence degree, the second influence degree, and the third influence degree as the influence degree of the target entity 10 on the related entity 20.

As the statistical value, a simple sum, a weighted sum, a simple average, a weighted average, or the like can be used. The weight of each element is determined in advance. The information indicating these weights is stored in advance in, for example, a storage unit accessible from the risk information generation apparatus 2000.

### Generation of Risk Information 40: S108

The generation unit 2080 generates the risk information 40 (S108). For example, the generation unit 2080 generates the risk information 40 indicating a text indicating the measure adequacy of the target entity 10 and a text indicating the influence degree of the target entity 10 on the related entity 20.

In addition, for example, the generation unit 2080 may generate the risk information 40 including a graph showing a pair of the measure adequacy of the target entity 10 and the influence degree of the target entity 10 on the related entity 20. Hereinafter, a graph showing a pair of the measure adequacy and the influence degree is referred to as a risk graph.

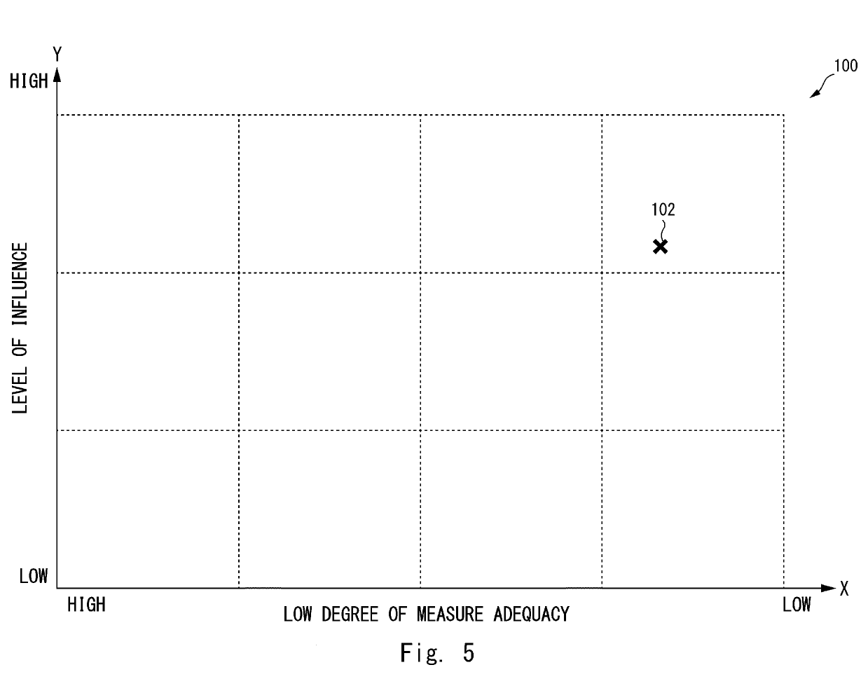

FIG. 5 is a diagram illustrating the risk graph. In the risk graph 100 of FIG. 5, the X-axis represents the low degree of the measure adequacy, and the Y-axis represents the level of influence. The risk graph 100 of FIG. 5 shows a point 102 representing a pair of the measure adequacy of the target entity 10 and the influence degree of the target entity 10 on the related entity 20.

Here, since the low degree of the measure adequacy is represented in the X-axis direction, in the risk graph 100 of FIG. 5, the measure adequacy becomes lower as the distance from the origin increases. The same applies to other risk graphs 100 illustrated below.

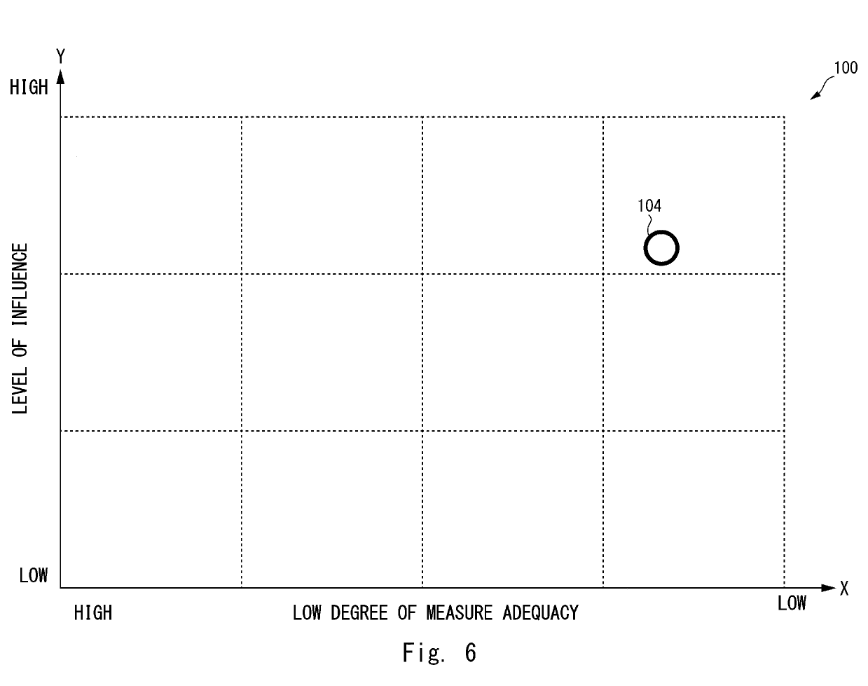

FIG. 6 is a second diagram illustrating the risk graph. The risk graph 100 of FIG. 6 is a so-called bubble chart, and shows a mark 104 instead of the point 102. The size of the mark 104 indicates some feature other than the measure adequacy and the influence degree for the target entity 10. For example, the size of the mark 104 represents the size of the scale of the target entity 10.

### Determination of Target Entity 10 Requiring Caution

For the user (e.g., a party of the related entity 20) of the risk information generation apparatus 2000, it can be said that the target entity 10 having a low measure adequacy and a high influence degree is an entity to be particularly noted. Therefore, it is preferable for the related entity 20 to be able to easily grasp the target entity 10 having a low measure adequacy and a high influence degree. Hereinafter, as described above, the target entity 10 having a low measure adequacy and a high influence degree on the related entity 20 is referred to as a caution-required entity.

The generation unit 2080 may determine whether the target entity 10 is a caution-required entity. For this purpose, the generation unit 2080 determines whether the measure adequacy of the target entity 10 is equal to or less than a first threshold value. The first threshold value is a value representing a boundary between a sufficiently high measure adequacy and a not sufficiently high measure adequacy. In addition, the generation unit 2080 determines whether the influence degree of the target entity 10 on the related entity 20 is equal to or greater than a second threshold value. The second threshold value is a value representing a boundary between a sufficiently high influence degree and a not sufficiently high influence degree.

The generation unit 2080 determines the target entity 10 as a caution-required entity in a case where it is determined that the measure adequacy is equal to or less than the first threshold value and it is determined that the influence degree is equal to or greater than the second threshold value for the target entity 10.

The first threshold value and the second threshold value may be determined in advance, or may be designated by the user of the risk information generation apparatus 2000.

The generation unit 2080 may further include information indicating whether the target entity 10 is a caution-required entity in the risk information 40. With this configuration, the user of the risk information generation apparatus 2000 can easily grasp whether the target entity 10 is an entity that requires caution.

For example, the generation unit 2080 generates the risk information 40 indicating a text indicating the measure adequacy of the target entity 10, a text indicating the influence degree of the target entity 10 on the related entity 20, and a text indicating whether the target entity 10 is a caution-required entity.

In addition, for example, the generation unit 2080 may generate a risk graph showing whether the target entity 10 is a caution-required entity. For example, the generation unit 2080 sets the display mode of the point 102 in a case where the target entity 10 is a caution-required entity and the display mode of the point 102 in a case where the target entity 10 is not a caution-required entity to display modes different from each other. More specifically, the generation unit 2080 sets a color, a shape, or both to be different between the point 102 in a case where the target entity 10 is a caution-required entity and the point 102 in a case where the target entity 10 is not a caution-required entity. The same applies to the case of using the mark 104.

In addition, for example, the generation unit 2080 may make the range of the risk graph 100 on which the caution-required entities are plotted distinguishable from other ranges. For example, the generation unit 2080 adds a color or a pattern different from those of other ranges to the range in which the caution-required entities are plotted.

### Output of Risk Information 40

The risk information generation apparatus 2000 outputs the risk information 40 by various methods. For example, the risk information generation apparatus 2000 stores the risk information 40 in any storage unit. In addition, for example, the risk information generation apparatus 2000 outputs the risk information 40 to a display device or the like to display the risk information 40 on the display device or the like. In addition, for example, the risk information generation apparatus 2000 transmits the risk information 40 to other apparatuses. For example, as described above, assume that the user of the risk information generation apparatus 2000 uses the risk information generation apparatus 2000 from the user terminal via the web system. In this case, the risk information generation apparatus 2000 transmits the risk information 40 to the user terminal.

### Graph for A Plurality of Entities

The risk information generation apparatus 2000 may determine a pair of the measure adequacy and the influence degree for each of the plurality of target entities 10. At this time, the related entity 20 is common among the plurality of target entities 10. In a case where the measure adequacy and the influence degree are determined for each of the plurality of target entities 10, the first determination unit 2040 suitably generates the risk information 40 in which information on the plurality of target entities 10 is aggregated.

For example, the risk information 40 includes a table in which a pair of the measure adequacy of the target entity 10 and the influence degree of the target entity 10 on the related entity 20 is indicated for each target entity 10. Each row of the table indicates the measure adequacy of the target entity 10 and the influence degree of the target entity 10 on the related entity 20 in association with the identifier of the target entity 10.

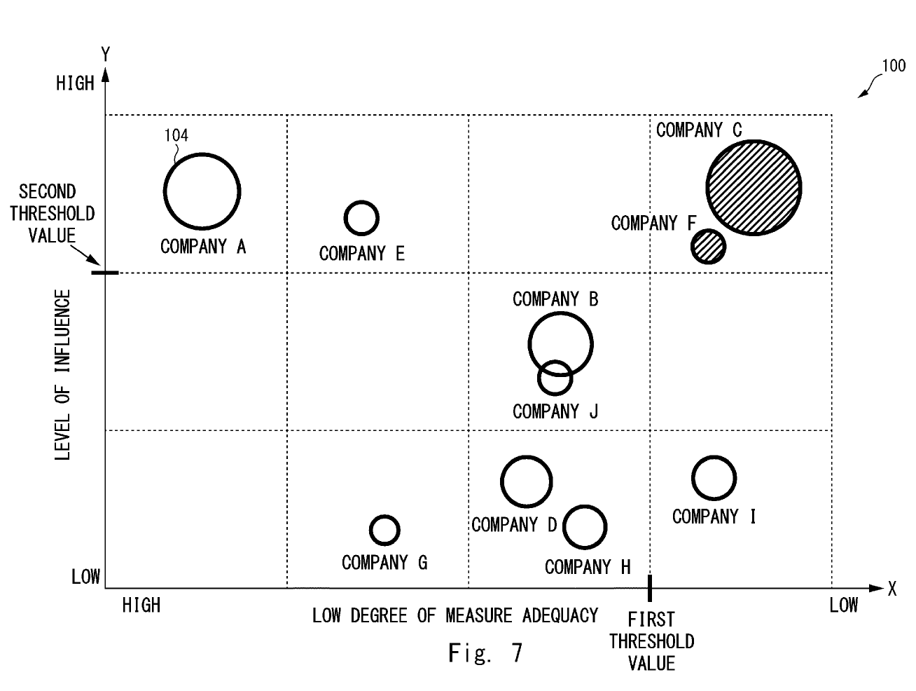

In addition, for example, the risk information 40 includes a risk graph 100 in which information on the plurality of target entities 10 is aggregated. FIG. 7 illustrates a risk graph in which information on the plurality of target entities 10 is aggregated.

In FIG. 7, one mark 104 represents, for one target entity 10, the influence degree in the X coordinate, the measure adequacy in the Y coordinate, and the scale in the size. Furthermore, the name of the target entity 10 is given to each mark 104. Moreover, in FIG. 7, the mark 104 in which the measure adequacy is equal to or less than the first threshold value and the influence degree is equal to or greater than the second threshold value is shaded.

The risk graph 100 in FIG. 7 represents a distribution of risk for the plurality of target entities 10 related to the related entity 20, the risk being represented by a combination of the low degree of the measure adequacy of the target entity 10, the level of influence of the target entity 10 on the related entity 20, and the scale of the target entity 10. With the distribution, the risk can be easily grasped for the plurality of target entities 10 related to the related entity 20.

The risk graph 100 may further indicate information regarding handling of personal information for the target entity 10. For example, the risk information generation apparatus 2000 determines whether important personal information is handled for each target entity 10. Then, the risk information generation apparatus 2000 generates the risk graph 100 in a mode in which whether important personal information is being handled can be identified from the mark for each target entity 10. For example, the mark of the target entity 10 handling important personal information and the mark of the target entity 10 not handling important personal information have different colors and shapes from each other.

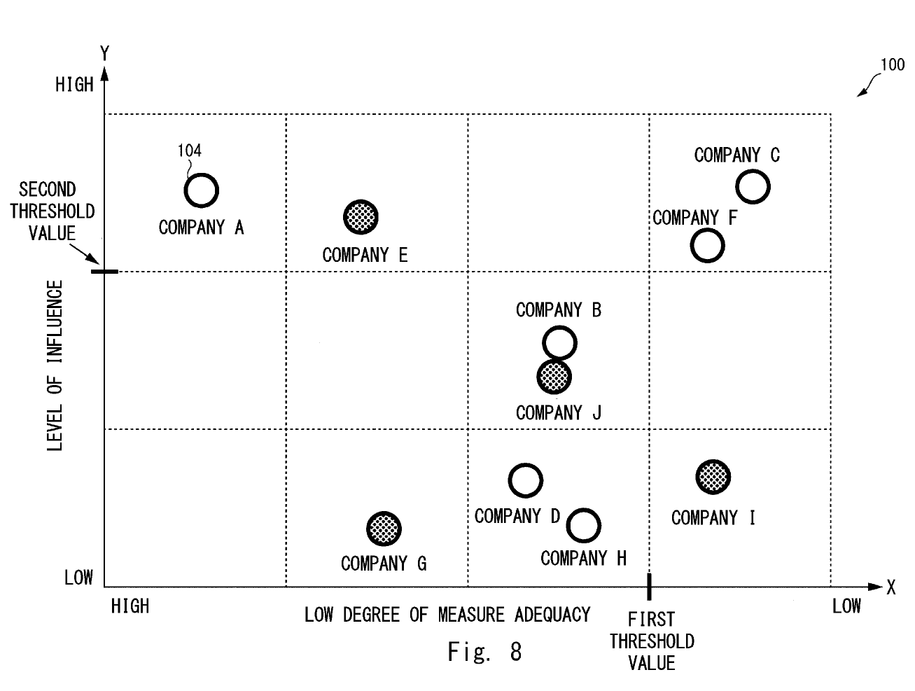

FIG. 8 is a diagram illustrating a risk graph 100 further showing information regarding handling of personal information. In FIG. 8, the mark 104 of the target entity 10 handling important personal information is represented by a dot pattern. On the other hand, the mark 104 of the target entity 10 not handling important personal information is represented in white.

In FIG. 8, the size of each mark 104 is the same. In this regard, as described with reference to FIG. 7, the risk information generation apparatus 2000 may change the size of each mark 104 in accordance with the scale of the target entity 10 in FIG. 8 as well.

There are various methods for determining whether important personal information is handled by each target entity 10. For example, the risk information generation apparatus 2000 acquires, for each target entity 10, information indicating whether important personal information is handled by the target entity 10. By using the acquired information, it is possible to determine whether important personal information is handled by each target entity 10.

In addition, for example, the risk information generation apparatus 2000 acquires, for each target entity 10, information indicating the type of personal information handled by the target entity 10. The risk information generation apparatus 2000 determines whether a predetermined type is included in the types of personal information handled by the target entity 10. In a case where the predetermined type is included in the types of personal information handled by the target entity 10, the risk information generation apparatus 2000 determines that important personal information is handled by the target entity 10.

Whether important personal information is handled by the target entity 10 and the type of personal information handled by the target entity 10 may be indicated in the audit information 30 or may be indicated in other information.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims. And each example embodiment can be appropriately combined with other example embodiments.

Each drawing is merely illustrative for describing one or more example embodiments. Each of the drawings is not associated with only one specific example embodiment, but may be associated with one or more other example embodiments. As those of ordinary skill in the art will appreciate, various features or steps described with reference to any one of the drawings may be combined with features or steps illustrated in one or more other drawings, for example, to create an example embodiment that is not explicitly illustrated nor described. All of the features or steps illustrated in any one of the drawings for describing illustrative example embodiments are not necessarily mandatory, and some features or steps may be omitted. The order of the steps described in any one of the drawings may be changed as appropriate.

The program includes instructions (or software codes) for causing the computer to perform one or more functions described in the example embodiment in a case of being read by the computer. The programs may be stored in a non-transitory computer-readable medium or a tangible storage medium. As an example and not by way of limitation, the computer-readable medium or the tangible storage medium includes a random-access memory (RAM), a read-only memory (ROM), a flash memory, a solid-state drive (SSD) or any other memory technology, a CD-ROM, a digital versatile disc (DVD), a Blu-ray (registered trademark) disc or any other optical disc storage, and a magnetic cassette, a magnetic tape, a magnetic disk storage, or any other magnetic storage device. The program may be transmitted through a transitory computer-readable medium or a communication medium. As an example and not by way of limitation, transitory computer-readable or communication media include electrical, optical, acoustic, or other forms of propagated signals.

Some or all of the example embodiments described above may also be described as, but are not limited to, the following Supplementary Notes.

### Supplementary Note 1

A risk information generation apparatus comprising:

at least one memory that is configured to store instructions; and

at least one processor that is configured to execute the instructions to:

acquire audit information indicating a result of a security audit performed on a target entity;

determine adequacy of security measures in the target entity by using the audit information;

determine an influence degree of the target entity on a related entity related to the target entity; and

generate risk information indicating the adequacy and the influence degree.

### Supplementary Note 2

The risk information generation apparatus according to supplementary note 1,

wherein the acquisition of the audit information includes acquiring the audit information for each of a plurality of the target entities,

wherein the determination of the adequacy of security measures includes determining the adequacy for each of the plurality of target entities,

wherein the determination of the influence degree includes determining the influence degree for each of the plurality of target entities, and

wherein the generation of the risk information includes generating the risk information indicating a combination of the adequacy and the influence degree for each of the plurality of the target entities.

### Supplementary Note 3

The risk information generation apparatus according to supplementary note 2,

wherein the generation of the risk information includes: generating a graph in which a mark is plotted on a coordinate determined by a combination of the adequacy and the influence degree for each of the plurality of the target entities; and including the graph in the risk information, and

wherein a mode of the mark of the target entity is determined based on a scale of the target entity.

### Supplementary Note 4

The risk information generation apparatus according to supplementary note 2,

wherein the generation of the risk information includes: generating a graph in which a mark is plotted on a coordinate determined by a combination of the adequacy and the influence degree for each of the plurality of the target entities; and including the graph in the risk information, and

wherein a mode of the mark of the target entity is different between a case where important personal information is handled by the target entity and a case where important personal information is not handled by the target entity.

### Supplementary Note 5

The risk information generation apparatus according to any one of supplementary notes 1 to 4,

wherein the generation of the risk information includes:

determining whether the adequacy is equal to or less than a first threshold value and whether the influence degree is equal to or greater than a second threshold value; and

including information indicating results of the determinations in the risk information.

### Supplementary Note 6

The risk information generation apparatus according to any one of supplementary notes 1 to 4, wherein the determination of the influence degree includes determining the influence degree based on a positional relationship between the target entity and the related entity in a hierarchy of a group to which both the target entity and the related entity belong.

### Supplementary Note 7

The risk information generation apparatus according to any one of supplementary notes 1 to 4, wherein the determination of the influence degree includes determining the influence degree based on a type of business outsourced from the related entity to the target entity, a scale of the business, or both of the type and the scale.

### Supplementary Note 8

The risk information generation apparatus according to any one of supplementary notes 1 to 4, wherein the determination of the influence degree includes determining the influence degree based on a type of product or service provided from the related entity to the target entity, a scale of the provision, or both of the type and the scale.

### Supplementary Note 9

A risk information generation method performed by at least one computer, comprising:

acquiring audit information indicating a result of a security audit performed on a target entity;

determining adequacy of security measures in the target entity by using the audit information;

determining an influence degree of the target entity on a related entity related to the target entity; and

generating risk information indicating the adequacy and the influence degree.

### Supplementary Note 10

The risk information generation method according to supplementary note 9,

wherein the acquisition of the audit information includes acquiring the audit information for each of a plurality of the target entities,

wherein the determination of the adequacy of security measures includes determining the adequacy for each of the plurality of target entities,

wherein the determination of the influence degree includes determining the influence degree for each of the plurality of target entities, and

wherein the generation of the risk information includes generating the risk information indicating a combination of the adequacy and the influence degree for each of the plurality of the target entities.

### Supplementary Note 11

The risk information generation method according to supplementary note 10,

wherein the generation of the risk information includes: generating a graph in which a mark is plotted on a coordinate determined by a combination of the adequacy and the influence degree for each of the plurality of the target entities; and including the graph in the risk information, and

wherein a mode of the mark of the target entity is determined based on a scale of the target entity.

### Supplementary Note 12

The risk information generation method according to supplementary note 10,

wherein the generation of the risk information includes: generating a graph in which a mark is plotted on a coordinate determined by a combination of the adequacy and the influence degree for each of the plurality of the target entities; and including the graph in the risk information, and

wherein a mode of the mark of the target entity is different between a case where important personal information is handled by the target entity and a case where important personal information is not handled by the target entity.

### Supplementary Note 13

The risk information generation method according to any one of supplementary notes 9 to 12,

wherein the generation of the risk information includes:

determining whether the adequacy is equal to or less than a first threshold value and whether the influence degree is equal to or greater than a second threshold value; and

including information indicating results of the determinations in the risk information.

### Supplementary Note 14

The risk information generation method according to any one of supplementary notes 9 to 12, wherein the determination of the influence degree includes determining the influence degree based on a positional relationship between the target entity and the related entity in a hierarchy of a group to which both the target entity and the related entity belong.

### Supplementary Note 15

A non-transitory computer-readable medium storing a program that causes at least one computer to execute:

acquiring audit information indicating a result of a security audit performed on a target entity;

determining adequacy of security measures in the target entity by using the audit information;

determining an influence degree of the target entity on a related entity related to the target entity; and

generating risk information indicating the adequacy and the influence degree.

### Supplementary Note 16

The medium according to supplementary note 15,

wherein the acquisition of the audit information includes acquiring the audit information for each of a plurality of the target entities,

wherein the determination of the adequacy of security measures includes determining the adequacy for each of the plurality of target entities,

wherein the determination of the influence degree includes determining the influence degree for each of the plurality of target entities, and

wherein the generation of the risk information includes generating the risk information indicating a combination of the adequacy and the influence degree for each of the plurality of the target entities.

### Supplementary Note 17

The medium according to supplementary note 16,

wherein the generation of the risk information includes: generating a graph in which a mark is plotted on a coordinate determined by a combination of the adequacy and the influence degree for each of the plurality of the target entities; and including the graph in the risk information, and

wherein a mode of the mark of the target entity is determined based on a scale of the target entity.

### Supplementary Note 18

The medium according to supplementary note 16,

wherein the generation of the risk information includes: generating a graph in which a mark is plotted on a coordinate determined by a combination of the adequacy and the influence degree for each of the plurality of the target entities; and including the graph in the risk information, and

wherein a mode of the mark of the target entity is different between a case where important personal information is handled by the target entity and a case where important personal information is not handled by the target entity.

### Supplementary Note 19

The medium according to any one of supplementary notes 15 to 18,

wherein the generation of the risk information includes:

determining whether the adequacy is equal to or less than a first threshold value and whether the influence degree is equal to or greater than a second threshold value; and

including information indicating results of the determinations in the risk information.

### Supplementary Note 20

The medium according to any one of supplementary notes 15 to 18, wherein the determination of the influence degree includes determining the influence degree based on a positional relationship between the target entity and the related entity in a hierarchy of a group to which both the target entity and the related entity belong.

1. A risk information generation apparatus comprising:
at least one memory that is configured to store instructions; and
at least one processor that is configured to execute the instructions to:
acquire audit information indicating a result of a security audit performed on a target entity;
determine adequacy of security measures in the target entity by using the audit information;
determine an influence degree of the target entity on a related entity related to the target entity; and
generate risk information indicating the adequacy and the influence degree.

2. The risk information generation apparatus according to claim 1,
wherein the acquisition of the audit information includes acquiring the audit information for each of a plurality of the target entities,
wherein the determination of the adequacy of security measures includes determining the adequacy for each of the plurality of target entities,
wherein the determination of the influence degree includes determining the influence degree for each of the plurality of target entities, and
wherein the generation of the risk information includes generating the risk information indicating a combination of the adequacy and the influence degree for each of the plurality of the target entities.

3. The risk information generation apparatus according to claim 2,
wherein the generation of the risk information includes: generating a graph in which a mark is plotted on a coordinate determined by a combination of the adequacy and the influence degree for each of the plurality of the target entities; and including the graph in the risk information, and
wherein a mode of the mark of the target entity is determined based on a scale of the target entity.

4. The risk information generation apparatus according to claim 2,
wherein the generation of the risk information includes: generating a graph in which a mark is plotted on a coordinate determined by a combination of the adequacy and the influence degree for each of the plurality of the target entities; and including the graph in the risk information, and
wherein a mode of the mark of the target entity is different between a case where important personal information is handled by the target entity and a case where important personal information is not handled by the target entity.

5. The risk information generation apparatus according to claim 1,
wherein the generation of the risk information includes:
determining whether the adequacy is equal to or less than a first threshold value and whether the influence degree is equal to or greater than a second threshold value; and
including information indicating results of the determinations in the risk information.

6. The risk information generation apparatus according to claim 1, wherein the determination of the influence degree includes determining the influence degree based on a positional relationship between the target entity and the related entity in a hierarchy of a group to which both the target entity and the related entity belong.

7. The risk information generation apparatus according to claim 1, wherein the determination of the influence degree includes determining the influence degree based on a type of business outsourced from the related entity to the target entity, a scale of the business, or both of the type and the scale.

8. The risk information generation apparatus according to claim 1, wherein the determination of the influence degree includes determining the influence degree based on a type of product or service provided from the related entity to the target entity, a scale of the provision, or both of the type and the scale.

9. A risk information generation method performed by at least one computer, comprising:
acquiring audit information indicating a result of a security audit performed on a target entity;
determining adequacy of security measures in the target entity by using the audit information;
determining an influence degree of the target entity on a related entity related to the target entity; and
generating risk information indicating the adequacy and the influence degree.

10. The risk information generation method according to claim 9,
wherein the acquisition of the audit information includes acquiring the audit information for each of a plurality of the target entities,
wherein the determination of the adequacy of security measures includes determining the adequacy for each of the plurality of target entities,
wherein the determination of the influence degree includes determining the influence degree for each of the plurality of target entities, and
wherein the generation of the risk information includes generating the risk information indicating a combination of the adequacy and the influence degree for each of the plurality of the target entities.

11. The risk information generation method according to claim 10,
wherein the generation of the risk information includes: generating a graph in which a mark is plotted on a coordinate determined by a combination of the adequacy and the influence degree for each of the plurality of the target entities; and including the graph in the risk information, and
wherein a mode of the mark of the target entity is determined based on a scale of the target entity.

12. The risk information generation method according to claim 10,
wherein the generation of the risk information includes: generating a graph in which a mark is plotted on a coordinate determined by a combination of the adequacy and the influence degree for each of the plurality of the target entities; and including the graph in the risk information, and
wherein a mode of the mark of the target entity is different between a case where important personal information is handled by the target entity and a case where important personal information is not handled by the target entity.

13. The risk information generation method according to claim 9,
wherein the generation of the risk information includes:
determining whether the adequacy is equal to or less than a first threshold value and whether the influence degree is equal to or greater than a second threshold value; and
including information indicating results of the determinations in the risk information.

14. The risk information generation method according to claim 9, wherein the determination of the influence degree includes determining the influence degree based on a positional relationship between the target entity and the related entity in a hierarchy of a group to which both the target entity and the related entity belong.

15. A non-transitory computer-readable medium storing a program that causes at least one computer to execute:
acquiring audit information indicating a result of a security audit performed on a target entity;
determining adequacy of security measures in the target entity by using the audit information;
determining an influence degree of the target entity on a related entity related to the target entity; and
generating risk information indicating the adequacy and the influence degree.

16. The medium according to claim 15,
wherein the acquisition of the audit information includes acquiring the audit information for each of a plurality of the target entities,
wherein the determination of the adequacy of security measures includes determining the adequacy for each of the plurality of target entities,
wherein the determination of the influence degree includes determining the influence degree for each of the plurality of target entities, and
wherein the generation of the risk information includes generating the risk information indicating a combination of the adequacy and the influence degree for each of the plurality of the target entities.

17. The medium according to claim 16,
wherein the generation of the risk information includes: generating a graph in which a mark is plotted on a coordinate determined by a combination of the adequacy and the influence degree for each of the plurality of the target entities; and including the graph in the risk information, and
wherein a mode of the mark of the target entity is determined based on a scale of the target entity.

18. The medium according to claim 16,
wherein the generation of the risk information includes: generating a graph in which a mark is plotted on a coordinate determined by a combination of the adequacy and the influence degree for each of the plurality of the target entities; and including the graph in the risk information, and
wherein a mode of the mark of the target entity is different between a case where important personal information is handled by the target entity and a case where important personal information is not handled by the target entity.

19. The medium according to claim 15,
wherein the generation of the risk information includes:
determining whether the adequacy is equal to or less than a first threshold value and whether the influence degree is equal to or greater than a second threshold value; and
including information indicating results of the determinations in the risk information.

20. The medium according to claim 15, wherein the determination of the influence degree includes determining the influence degree based on a positional relationship between the target entity and the related entity in a hierarchy of a group to which both the target entity and the related entity belong.
